(19) United States
(12) Patent Application Publication
(10) Pub. No.: US 2008/0264976 A1
(43) Pub. Date: Oct. 30, 2008

(54) FLUID DISPENSER INCLUDING A COMPONENT ELEMENT

(75) Inventors: Emilie BOULOUARD, Saint Arnoult (FR); Helene CHEVALIER, Saint Didier Des Bois (FR)

Correspondence Address: SUGHRUE MION, PLLC, 2100 PENNSYLVANIA AVENUE, N.W., SUITE 800, WASHINGTON, DC, 20037, US

(73) Assignee: VALOIS SAS, Le Neubourg (FR)

(21) Appl. No.: 12/110,941

(22) Filed: Apr. 28, 2008

Related U.S. Application Data
(60) Provisional application No. 60/948,797, filed on Jul. 10, 2007.

(30) Foreign Application Priority Data
Apr. 27, 2007 (FR) FR.07-54744

(51) Int. Cl. B05B 11/00; B65D 47/34; B67D 5/06; B05B 9/043; B67D 5/42; G01F 11/00

(52) U.S. Cl. 222/321.9

(57) ABSTRACT

A dispenser including as its component elements: a fluid reservoir (1); a dispenser member (2), such as a pump or a valve, mounted on the reservoir by means of a fastener member (3); and at least one decorative covering element (34, 6, 7) associated with the reservoir (1), with the dispenser member (2), and/or with the fastener member (3), and a member (5, 6) that must be removed from the dispenser in order to actuate it, said element being characterized in that it comprises at least one biodegradable material.

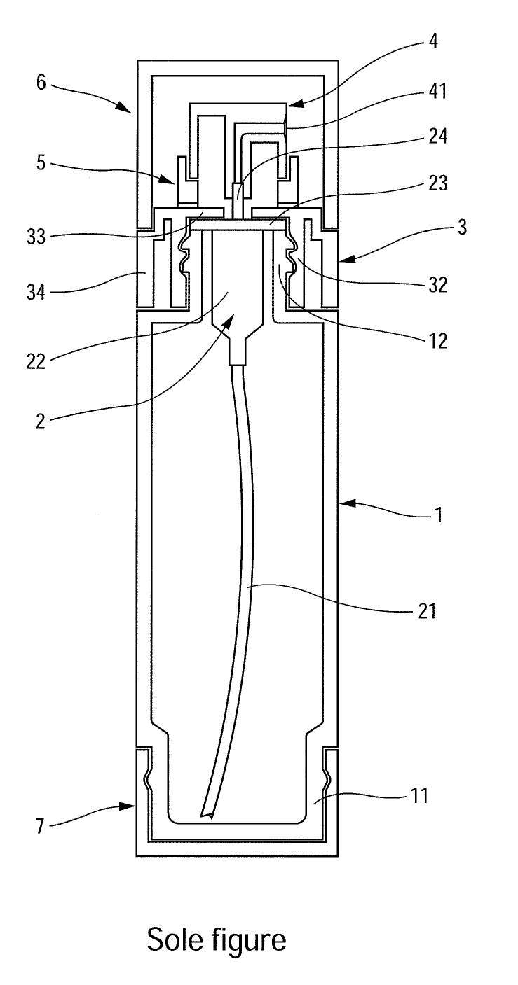

### CROSS REFERENCE TO RELATED APPLICATION

This application claims the benefit under 35 U.S.C. §119(e) of pending U.S. provisional patent application Ser. No. 60/948,797, filed Jul. 10, 2007, and priority under 35 U.S.C. §119(a)-(d) of French patent application No. FR-07.54744, filed Apr. 27, 2007.

### TECHNICAL FIELD

The present invention relates to a fluid dispenser including as its component elements: a fluid reservoir; a dispenser member, such as a pump or a valve, mounted on the reservoir by means of a fastener member; and at least one decorative covering element associated with the reservoir, with the dispenser member, and/or with the fastener member. The invention also relates to a fluid dispenser including one or more component elements of the invention. Such fluid dispensers are frequently used in the fields of perfumery, cosmetics, or even pharmacy, for dispensing fluids, such as perfumes, creams, gels, medication in liquid or powder form, etc.

### BACKGROUND OF THE INVENTION

Conventional dispensers are generally made out of materials such as plastics materials, glass, and metal. More particularly, it is useful to make the dispenser member (pump or valve) out of a plastics material such as polyethylene or polypropylene, for example. The dispenser member can even include component elements made out of metal, e.g. such as a return spring or a movable valve member in the form of a ball-bearing. The dispenser member can also include decorative coverings made out of metal. The same can also apply to the fastener member that can comprise an outer covering hoop made out of metal. With regard to the reservoir, it is generally made of glass, but it could also be made out of plastics material or out of metal, e.g. aluminum.

For some time now, there have been increasing requirements for fluid dispensers to be recyclable in part, or advantageously in full. Very often they are not recyclable because different component materials are used together, e.g. to make the dispenser member. However, dispensers exist that can be recycled easily and completely. This requires the dispenser to be completely disassembled, so as to separate at least the dispenser member from the reservoir. Then, it is also necessary to sort out the various component elements as a function of the materials from which they are made. Recycling is certainly beneficial to the environment, but it incurs a processing cost that is very high.

### BRIEF SUMMARY OF THE INVENTION

An object of the present invention is to remedy the above-mentioned drawbacks of the prior art by defining a new type of component element that is not harmful to the environment and that does not lead to a recycling cost that is high.

To do this, the present invention proposes a dispenser including as its component elements: a fluid reservoir; a dispenser member, such as a pump or a valve, mounted on the reservoir by means of a fastener member; and at least one decorative covering element associated with the reservoir, with the dispenser member, and/or with the fastener member, and a member that must be removed from the dispenser in order to actuate it, said element being characterized in that it comprises at least one biodegradable material. It is therefore no longer necessary to recycle the movable element; on the contrary, it spoils naturally and degrades, e.g. in an appropriate environment, such as a damp environment.

The biodegradable material is advantageously selected from potato starch, corn starch, potato flour, cereal flour, wood, cellulose, biodegradable polymers, polylactide (PLA), polyalkanoate acid (PHA), biodegradable petrochemical derivatives, or a mixture thereof. If necessary, the biodegradable material may be mixed with a non-biodegradable material. For example, it is possible to mix the biodegradable material with a plastics material so as to impart particular properties thereto.

In another aspect of the invention, the movable element is not in contact with the fluid to be dispensed. Advantageously, the movable element is a decorative covering element. In a practical the embodiment, the movable element is a first-use safety member or a protective cap. Given that this type of member is not connected integrally to the dispenser, it can be lost by accident or even thrown away deliberately. By means of the invention, it does not harm the environment, since it is biodegradable.

### BRIEF DESCRIPTION OF THE DRAWINGS

The invention is described more fully below with reference to the accompanying sole FIGURE which shows a non-limiting embodiment.

The sole FIGURE is a vertical section showing a fluid dispenser comprising a plurality of biodegradable component elements.

### DETAILED DESCRIPTION

The dispenser shown in the sole FIGURE comprises a plurality of component elements, namely: a reservoir 1; a dispenser member 2 which, in this embodiment, is a pump; a fastener ring 3 for fastening the pump on the reservoir; a first-use safety collar 5; a protective cap 6, and a decorative cup 7. The collar 5, the cap 6, and the cup 7 are optional parts. Instead of the pump 2, it is also possible to provide another type of dispenser member, such as a valve.

The reservoir 1 is for containing the fluid to be dispensed. The reservoir can be made out of any appropriate material, such as glass, plastics material, metal, or even out of a biodegradable material of the invention. The biodegradable material can be mixed with another material that is not biodegradable, such as a plastics material. The reservoir includes a bottom wall 11 at its bottom end and a neck 12 at its top end. The neck 12 defines an opening that puts the inside of the reservoir into communication with the outside. The bottom wall 11 is provided with a decorative covering cup 7 that is fastened to the bottom wall by any appropriate means, such as by snap-fastening, by clamping, by adhesive, etc. The decorative cup 7 can be made out of any appropriate material, and advantageously out of a biodegradable material, which may be used on its own or mixed with another material that is not biodegradable.

The pump 2 can be of any type: its internal mechanism is not critical and is therefore not described below. The pump 2 generally comprises: a pump body 22; a dip tube 21 that extends from the inlet of the pump to the bottom wall 11 of the reservoir; a fastener collar 23; and an actuator rod 24 that is axially displaceable down and up in the body 22 against a return spring (not shown). The pump 2 defines a pump chamber in which a dose of fluid can be put under pressure by actuating the rod 24. The pump 2 is made from a plurality of component elements, such as the body 22, the dip tube 21, the actuator rod 24, and even a piston (not shown). All or only some of the component elements can be made out of a biodegradable material, which may be used on its own or mixed with another material that is not biodegradable.

The pump 2 is provided with an actuator head 4 which, in this embodiment, is in the form of a pusher mounted on the free end of the actuator rod 24. The dispenser head 4 defines a dispenser orifice 41 that communicates with the actuator rod. By pressing axially on the head 4, the actuator rod 24 is displaced inside the body 22 of the pump, thereby dispensing a dose of fluid. This type of operation is quite conventional for a pump in the fields of perfumery, cosmetics, or even pharmacy.

In order to hold the pump 2 in the neck 12 of the reservoir, a fastener ring 3 is provided which, in this embodiment, comprises: a fastener skirt 32 that is engaged with the neck 12; a bearing plate 33 that presses the collar 23 against the top edge of the neck 12; and an outer covering hoop 34. The hoop 34 is the only portion of the fastener ring 3 that is visible. The ring 3 can be made out of any appropriate material, and advantageously out of a biodegradable material, which may be used on its own or mixed with another material that is not biodegradable.

The first-use safety collar 5 can be made integrally with the fastener ring 3, for example. The collar 5 can be connected to the ring 3 via breakable bridges of material, so as to make it easy to detach the collar 5 from the ring 3. The collar 5 surrounds the pusher 4 in such a manner as to prevent it from being displaced axially. It is therefore impossible to actuate the pusher while the collar 5 is in place. Before the dispenser is used for the first time, the user must remove the collar 5 so as to enable the pusher to be displaced axially. The user can then displace the pusher axially by pressing thereon with one or more fingers. Just like the ring 3, the collar 5 can be made out of any appropriate material, and advantageously out of a biodegradable material, which may be used on its own or mixed with another material that is not biodegradable.

The protective cap 6 covers the pusher 4 and the collar 5. The protective cap is held in position on a shoulder formed by the fastener ring 3. The protective cap can be made out of any appropriate material, and advantageously out of a biodegradable material, which may be used on its own or mixed with another material that is not biodegradable.

The fastener ring 3, the first-use safety collar 5, the protective cap 6, and the covering cup 7 are component elements that are not intended to come into contact with the fluid to be dispensed. In addition, they constitute decorative elements, given that they are visible to the user. These component elements can be made out of a biodegradable material more easily than the other component elements that are in contact with the fluid. It is particularly advantageous to make the first-use safety collar 5 out of biodegradable material, given that it is intended to be removed from the dispenser before said dispenser is used for the first time. The user must thus discard the collar 5. When it is made out of a material that is not biodegradable, it must be thrown away in a waste bin. By means of the invention, by making the collar 5 out of a material that is biodegradable, the user can quite simply throw the collar 5 away into the natural environment without any risk of harmful effects. The same applies for the cap 6, even though it is intended to be put back on the dispenser after each use.

In the context of the present invention and by way of example, as biodegradable material, it is possible to use materials based on potato or corn starch, cereal flour (e.g. native cereal flours), wood (e.g. liquid-wood composites), cellulose (e.g. wood cellulose), potato flour, biodegradable polymers (such as PLA and PHA, for example), or even biodegradable petrochemical derivatives. It is also possible to mix a plurality of biodegradable materials together, or to mix one or more biodegradable materials with non-biodegradable materials. Amongst the biodegradable materials, some can be composted so as to cause and encourage them to degrade.

The present invention, which applies more particularly to the fields of perfume, cosmetics, or pharmaceutical dispensers, makes it possible to eliminate the additional step of recycling that is costly and time-consuming.

1. A dispenser including as its component elements: a fluid reservoir (1); a dispenser member (2), such as a pump or a valve, mounted on the reservoir by means of a fastener member (3); and at least one decorative covering element (34, 6, 7) associated with the reservoir (1), with the dispenser member (2), and/or with the fastener member (3), and a member (5, 6) that must be removed from the dispenser in order to actuate it, said element being characterized in that it comprises at least one biodegradable material.

2. A dispenser according to claim 1, in which the biodegradable material is selected from potato starch, corn starch, potato flour, cereal flour, wood, cellulose, biodegradable polymers, polylactide (PLA), polyalkanoate acid (PHA), biodegradable petrochemical derivatives, or a mixture thereof.

3. A dispenser according to claim 1, in which the biodegradable material is mixed with a non-biodegradable material.

4. A dispenser according to claim 1, in which the element (3, 6, 7) is not in contact with the fluid to be dispensed.

5. A dispenser according to claim 4, in which the element is a decorative covering element.

6. A dispenser according to claim 1, in which the fluid is a perfume.

7. A dispenser according to claim 1, in which the dispenser member (2) comprises an axially movable pusher (4), the movable member (5) being a first-use safety member preventing the axial displacement of the pusher.

8. A dispenser according to claim 1, in which the dispenser member (2) comprises an axially movable pusher (4), the movable member (6) being a protective cap covering the pusher.
